(19) United States
(12) Patent Application Publication
(10) Pub. No.: US 2026/0297337 A1
(43) Pub. Date: Oct. 1, 2026

(54) METAL EFFECT PIGMENT PREPARATION FOR POWDER COATINGS

(71) Applicant: Schlenk Metallic Pigments GmbH, Roth (DE)

(72) Inventors: Adalbert HUBER, Bensheim (DE); Anneke JENINGA, Nürnberg (DE); Heinz HABERKERN, Georgensgmünd (DE); Joachim SCHULZE, Roth (DE)

(73) Assignee: Schlenk Metallic Pigments GmbH, Roth (DE)

(21) Appl. No.: 19/477,812

(22) PCT Filed: Apr. 18, 2024
(86) PCT No.: PCT/EP2024/060518

§ 371 Date: Oct. 23, 2025

(30) Foreign Application Priority Data
Apr. 26, 2023 (DE) 10 2023 110 771.2

(51) Int. Cl. C09D 5/03; C08K 3/08; C08K 9/02; C08K 9/08; C09C 1/64; C09D 7/40; C09D 7/62

(52) U.S. Cl. CPC C09D 5/035; C08K 3/08; C08K 9/02; C08K 9/08; C09C 1/646; C09C 1/648; C09D 7/62; C09D 7/70; C08K 2003/0812

(57) ABSTRACT

A metal effect pigment composition in granule form for use in powder coatings. The composition includes a metal effect pigment, a binder, and a surface-active additive. The metal effect pigment includes a metallic core and may include one or more layers of a metal oxide, metal hydroxide, or metal oxide hydrate disposed on the metallic core. The binder may be cellulose, a cellulose derivative, starch, a starch derivative or mixtures thereof.

The invention relates to the use of a metal effect pigment preparation in granule form in powder coatings and to a process for producing powder coatings.

Metal effect pigments, such as aluminium effect pigments, are often used in varnishes, paints, printing inks, cosmetics or plastics for colouring and for generating a metallic effect. The key function of metal effect pigments is the directed reflection of light at parallel-aligned pigment platelets.

In recent years, powder coatings have become increasingly popular, as these coatings naturally have a low content of volatile organic compounds (“VOC”), so significantly reducing emissions of volatile organic compounds into the atmosphere during application and curing. The environmentally friendly and versatile powder coatings can be used in numerous fields of application—generally for metal coating, with household appliances, for facade coating, as furniture coating or for automotive finishing. The powder coatings used as primers or single-coat topcoats are almost completely recyclable. Powder coatings typically contain binders, pigments, fillers and crosslinkers and also, optionally, additives. They are in a fine-particled form and are applied usually electrostatically to different substrates and hardened by baking or by radiative energy.

Powder coatings can be produced in a mixing process with subsequent extrusion and intensive grinding by comminution of the extrudate. However, this method is not suitable for effect pigments, as the shear forces in the extruder and during intensive mixing can damage or destroy the effect-imparting platelet-shaped form, and this can have a negative effect on the gloss and the visual effect of the pigments.

Effect pigments such as metal effect pigments are therefore often added to the base powder coating retrospectively (in a so-called dry-blend process). However, a disadvantage of this process is that because of the different charging characteristics and different specific weights of the individual coating constituents during coating application, a separation of pigment and powder coating binder can occur, which impairs the optical quality of the applied powder coating. In addition, the recyclability of such a powder coating with metal pigments is therefore no longer ensured for powder coatings produced by this process.

Another process for powder coating production is the so-called bonding process, in which the pigment is fixed to the particles of the basecoat (powder coating binder) with heating. By heating a mixture of powder coating and metal pigment up to the glass transition temperature of the powder coating binder, a physical connection of the metal pigment particles to the powder coating particles is achieved.

In the bonding process (as well as in the dry-blend process), the metal effect pigments are often used as fine-particled powder, which leads to a high dust load.

JP 2003213157 A discloses a metallic pigment for a powder coating composition with high metallic gloss. This aluminium pigment, which can be used in single-coat or multi-coat powder coatings, is coated with at least one resin component containing a fluorinated alkyl group. The coated aluminium effect pigments disclosed therein are used in powder coating by means of dry blending or by bonding, and are in non-dust-free powder form.

EP 2 896 661 A1 relates to a powder coating in particulate and cured form with effect pigments and to a process for producing powder coating material with effect pigments which are wetted to an extent of at least 50% by a viscous coating compound. In this case, an extruder is used to produce a film-forming, homogeneous, thermoplastic coating compound from the starting materials, in particular comprising binders, additives, colourants and/or fillers, and after leaving the extruder this compound is ground, with the effect pigments being added in an end region of the extruder and dispersed in the viscous coating compound. The composition of the finished powder coating here is identical to the composition used to clad the effect pigments. EP 3 144 352 describes a powder coating comprising at least one base powder coating and at least one effect powder coating with effect pigments, where the effect pigments are dispersed in a melt of transparent effect powder coating. In both cases, the freedom to formulate is restricted.

EP 3 500 630 describes a particulate pigment composition for powder coatings, in which the pigment is clad with a thermosetting resin (thermoset) having an acid number of 10 to 50 mg KOH/g resin. For the production of the pigment composition, the resin is typically dissolved in a solvent, more particularly an organic solvent, and then mixed with the pigment to be coated in paste form in an organic solvent. Organic solvents, in the examples more particularly aromatic solvents, must therefore be used in the production process. In addition, the storability of the pigment composition with a reactive thermosetting resin is subject to certain restrictions.

It is an object of the present invention to provide a metal effect pigment preparation for use in powder coatings, wherein the metal effect pigment preparation is in granule form and can therefore be metered in dust-free form. This improves handling and occupational safety. Furthermore, the metal effect pigment preparation in one preferred embodiment is to be producible in an aqueous system-without use of organic solvents.

This object is achieved by the use of a metal effect pigment preparation in a powder coating according to claim 1, and by a process for producing a powder coating according to claim 10. Further features, embodiments and advantages emerge from the dependent claims and the description.

One aspect of the invention relates to the use of a metal effect pigment preparation in powder coatings, characterized in that the metal effect pigment preparation is in granule form and comprises the following components:
a) 60-98% by weight, based on the total weight of the metal effect pigment preparation, of at least one metal effect pigment having a metallic core which optionally contains one or more metal oxide and/or metal hydroxide and/or metal oxide hydrate layers,
b) 1-30% by weight, based on the total weight of the metal effect pigment preparation, of at least one binder selected from cellulose, cellulose derivative, starch, starch derivative or mixtures thereof,
c) 1-30% by weight, based on the total weight of the metal effect pigment preparation, of a surface-active additive, and
d) less than 3% by weight, based on the total weight of the metal effect pigment preparation, of residual moisture, the residual moisture comprising water and organic solvents.

Components a) to d) make 100% by weight.

Another aspect of the invention relates to a process for producing a powder coating, which comprises the following steps:
a) producing a metal effect pigment preparation by mixing a metal effect pigment having a metallic core which optionally contains one or more metal oxide and/or metal hydroxide and/or metal oxide hydrate layers with at least one binder selected from cellulose, cellulose derivative, starch, starch derivative or mixtures thereof, and with a surface-active additive, compacting the resulting mixture in granule form, optionally drying the compacted mixture, wherein the metal effect pigment preparation is in granule form and comprises the following components:
   A) 60-98% by weight, based on the total weight of the metal effect pigment preparation, of at least one metal effect pigment having a metallic core which optionally contains one or more metal oxide and/or metal hydroxide and/or metal oxide hydrate layers,
   B) 1-30% by weight, based on the total weight of the metal effect pigment preparation, of at least one binder selected from cellulose, cellulose derivative, starch, starch derivative or mixtures thereof,
   C) 1-30% by weight, based on the total weight of the metal effect pigment preparation, of a surface-active additive, and
   D) less than 3% by weight, based on the total weight of the metal effect pigment preparation, of residual moisture, the residual moisture comprising water and organic solvents,
b) mixing the metal effect pigment preparation in granule form obtained in step a) together with a powder coating binder and optionally further constituents of a powder coating, and
c) bonding the mixture obtained in step b).

Another aspect of the invention relates to the powder coating thus obtained.

Surprisingly, the metal effect pigment preparation in granule form to be used according to the invention can be incorporated homogeneously in a powder coating without pigment aggregations or inhomogeneities occurring in the powder coating that would negatively influence the optical properties of the metal pigments. The presence of the binder based on cellulose, starch or derivatives thereof and the water-soluble additive means that the metal effect pigment preparation according to the invention shows no significant dust formation despite low residual moisture content. This improves handling and occupational safety. The powder coating obtained results in a coating having excellent optical properties such as gloss. Surprisingly, after bonding, the effect pigments have a very uniform alignment at the surface. The metal effect pigment preparation which can be used according to the invention can be employed in many powder coating systems. Another advantage of a preferred embodiment with a water-soluble binder is that the metal effect pigment preparation with the water-soluble cellulose derivative binder is produced in an aqueous system, without the need to use organic solvents.

The terms “metal effect pigment” and “metal pigment” are used synonymously in the context of the present invention. A metal effect pigment is understood to be a pigment which has a metallic core, preferably platelet-shaped and containing optionally one or more metal oxide and/or metal hydroxide and/or metal oxide hydrate layers. The average diameter of the metallic core is usually 1-250 μm, preferably 2-150 μm, in particular 5-100 μm. The thickness of the platelets is usually in the range of about 4 nm-2 μm, preferably 15-200 nm, in particular 30 to 140 nm or 60 to 120 nm. The ratio of diameter to thickness is generally 1500:1-20:1, preferably 1000:1-100:1, in particular 500:1-200:1. This ratio of diameter to thickness is referred to as form factor. The metal effect pigments can be produced by grinding (so-called cornflake or silver dollars, or very thin metal effect pigments produced by grinding) or by VMP/PVD processes.

A metal effect pigment preparation is understood to be a metal effect pigment composition.

A water-soluble binder is understood presently to mean that at least 10 g of the binder dissolve in 1 L of demineralized water at 20° C. and 1 bar pressure. A non-water-soluble binder is understood presently to mean that less than 10 g of the binder dissolve in 1 L of demineralized water at 20° C. and 1 bar pressure.

A surface-active additive is understood to be a substance which has the ability to lower the surface tension of water. A nonionic surface-active additive is understood to be a substance which contains no ionic functional groups, while an ionic additive contains one or more ionic functional groups. A surface-active additive can also be referred to as a surfactant.

A cellulose derivative is understood to be a chemical derivative of cellulose. Possible modifications are methylation (to give methylcellulose), ethylation, hydroxypropylation, etc. The cellulose derivatives may have different degrees of polymerization and substitution patterns. A starch derivative is understood to be a chemical derivative of starch. Modifications can be made by physical, enzymatic or chemical processes (e.g. esterification).

Bonding is understood to be a process in which the metal effect pigment is fixed to the particles of the basecoat (powder coating binder) with heating. By heating a mixture of powder coating and metal pigment up to the glass transition temperature of the powder coating binder, a physical connection of the metal pigment particles to the powder coating particles is achieved. In the bonding process, heating of the powder coating up to the glass transition point or higher is achieved by introduction of energy, e.g. by external heat sources or high shear forces.

A metal effect pigment preparation in granule form is understood to be a metal effect pigment preparation that is present as a free-flowing, coarse-grained material. The granules are preferably in cylindrical form (with diameters from about 0.5 mm to about 5 mm and lengths from about 1 mm to about 8 cm) or in spherical form (with diameters from about 0.05 to about 5 mm).

The metal effect pigment preparation used according to the invention comprises 60-98% by weight of at least one metal effect pigment, based on the total weight of the metal effect pigment preparation. In one preferred embodiment, the metal effect pigment preparation according to the invention contains 70-95% by weight, further preferably 75-93% by weight, in particular 80 to 91% by weight of at least one metal effect pigment, based on the total weight of the metal effect pigment preparation.

The metal effect pigment preparation used according to the invention further comprises 1-30% by weight, based on the total weight of the metal effect pigment preparation, of at least one water-soluble binder which is a cellulose derivative, preferably 3-25% by weight, further preferably 4-15% by weight, in particular 5-10% by weight of at least one cellulose derivative.

As a further component, the metal effect pigment preparation of the present invention comprises 1-30% by weight of a surface-active additive, based on the total weight of the metal effect pigment preparation, preferably 1.5-20% by weight, in particular 2-15% by weight, in particular 2.5-10% by weight.

A further advantage of the metal effect pigment preparation used according to the invention is the low residual moisture content and the presence in granule form. According to the invention, the metal effect pigment preparation contains less than 3% by weight, based on the total weight of the metal effect pigment preparation, of residual moisture, with the residual moisture comprising water and organic solvents. Preferably, the metal effect pigment preparation according to the invention contains less than 2.5% by weight of residual moisture, in particular less than 2% by weight of residual moisture.

The granule form of the pigment preparation can be obtained by various processes and have different size ranges. Preferably, the granules are in cylindrical form (with diameters from about 0.5 mm to about 5 mm and lengths from about 0.1 cm to about 8 cm). Preferably, the granules in cylindrical form of the metal effect pigment preparation which can be used according to the invention have a diameter of 1 to 3 mm and a length of 0.5 to 7 cm, more preferably still a diameter of 1.5 to 2.5 mm and a length of 1 to 5 cm. Such granules can be produced by conventional processes such as strand pressing, punch pressing (press with punch and perforated plate), or extrusion, including in particular low-pressure extrusion through a basket extruder, optionally with subsequent drying (at about 20° C. to 150° C.), and comminution with, for example, a rotating knife. Granules in spherical form (with diameters from about 0.05 to about 5 mm, in particular 1 to 3 mm) can be obtained by spray granulation and fluidized bed granulation or with a granulating plate, optionally with subsequent screening.

The pigment preparations in granule form that can be used according to the invention are notable for good abrasion resistance, good meterability and dust-free status. They can be incorporated well into powder coatings via the bonding process and are very compatible there, so resulting in high-gloss powder coatings. It was further evident (in SEM images) that the effect pigments in the bonded coating align very evenly at the surface of the coating, clearly more ordered than in comparison to a pigment preparation in powder form without the binders according to the invention. Surprisingly, powder coatings comprising the metal effect pigment preparation used according to the invention with binders based on cellulose, starch or their cellulose/starch derivatives in granule form had a significantly higher gloss than powder coatings with the corresponding metal effect mixture without these binders and in powder form.

Powder coatings used can be commercially available powder coatings, more particularly powder coatings based on polyurethane, epoxy, polyester/epoxy, polyester/Primid, polyester or acrylate systems. Carbonyl-functional polyesters (PES) are particularly preferred. The powder coatings can be transparent (e.g. AL96 from DuPont) or non-transparent, especially black with high gloss. Powder coatings contain binders and typically fillers and crosslinkers and also optionally additives and pigments.

The metal effect pigment of the invention is preferably an aluminium or iron effect pigment, more preferably an aluminium effect pigment.

The metal effect pigment can consist of the metallic core alone. In another embodiment, the metal effect pigment has one or more metal oxide and/or metal hydroxide and/or metal oxide hydrate layers on the metallic core. Furthermore, it is preferred that in the metal effect pigment preparation used according to the invention, the metal oxide and/or metal hydroxide and/or metal oxide hydrate layer is selected from the group consisting of oxides, hydroxides or oxide hydrates of the elements silicon, vanadium, molybdenum, chromium, titanium, iron, aluminium, tin and mixtures thereof. In one preferred embodiment, the one or more layer(s) is/are a metal oxide layer, in particular one metal oxide layer or two or three metal oxide layers of different metal oxides. In one preferred embodiment, the layer is an SiO₂ layer. In another preferred embodiment, the metal core comprises an SiO₂ layer on which there is an iron oxide layer. The layer thickness of the metal oxide, metal hydroxide and/or metal oxide hydrate layer is 3-270 nm (thickness of layer(s) in total) according to the invention. In one embodiment, the layer thickness is 7-100 nm, particularly preferably 10 to 50 nm. In another embodiment, the layer thickness is preferably 150-270 nm, particularly preferably 260 nm. The optional metal oxide and/or metal hydroxide and/or metal oxide hydrate layer can be modified with surface modifiers such as optionally functionalized silanes, for example alkyl-, alkoxy-, primary amino-, secondary amino-, epoxy-, isocyano-, mercapto-, azido-, (meth)acryloyl-, vinyl-, hydroxyl-functionalized silanes. Furthermore, the metal oxide and/or metal hydroxide and/or metal oxide hydrate layer can be coated with a polymer layer for stabilization, based for example on polyacrylates or polymethacrylates, polyurethanes, polyesters, epoxides or polyolefins; optionally, this layer can be modified with silanes.

The binder is selected from cellulose, cellulose derivative, starch, starch derivative or mixtures thereof, and may be water-soluble or non-water-soluble. Starch (usually a mixture of amylose and amylopectin) can be used in the form of potato starch, corn starch and wheat starch. It is a non-water-soluble binder. Starch derivatives can be prepared by physical, enzymatic or chemical processes (e.g. esterification) and, depending on modification, can be water-soluble or non-water-soluble. Cellulose is a non-water-soluble binder which can be used according to the invention. A cellulose derivative can be used as a water-soluble binder. Hydroxypropyl-methylcellulose (e.g. Methocel (DuPont), VIVAPHARM HPMC (JRS)), hydroxypropyl-cellulose (e.g. Klucel H (Ashland), Klucel E (Ashland)), hydroxyethyl-cellulose (e.g. Tylose HEC (SE Tylose GmbH)), methylhydroxy-ethylcellulose (e.g. Tylose MHEC (SE Tylose GmbH)) are preferred.

The surface-active additive is preferably a nonionic surface-active additive. Preferred nonionic additives include polyglycol, polyvinyl butyral (PVB) and/or polyvinylpyrrolidone (PVP) or polysiloxanes (e.g. Getren (Evonik)); a polyglycol is particularly preferred. The polyglycol is preferably a polyethylene glycol or polypropylene glycol, in particular a polyethylene glycol having an average molar mass of 200-600 g/mol, preferably with 300-500 g/mol, further preferably with 380-420 g/mol. A particularly preferred polyethylene glycol ether is PEG 400 (PCC Chemax Inc.). In this embodiment, the metal effect pigment preparation used according to the invention contains less than 500 ppm, preferably less than 20 ppm, of phosphorus, based on the total weight of the metal effect pigment preparation. In the prior art, metal effect pigment preparations often contain sizeable amounts of phosphorus as a result of using organic phosphates, phosphonates or phosphites, which do not need to be used in this embodiment of the present invention. This has the advantage that environmentally hazardous phosphorus compounds such as organic phosphates and phosphonates in particular can be omitted.

Ionic surface-active additives can also be used according to the invention. Preferred ionic additives include alkyl sulfates (e.g. Chemsulf (PCC Chemax Inc.), Rewopol (Evonik), ROSULfan E (PCC Chemax Inc.)), alkyl sulfosuccinates (e.g. PLANTAPON SUS (BASF), TEXAPON SB 3 KC (BASF), Genapol SBE (Clariant), Rewopol SB (Evonik)), alkylbenzene- and paraffinsulfonates (e.g. Marlon A (Sasol Chemicals), Marlopon AT (Sasol Chemicals)), secondary alkanesulfonates (e.g. MERSOLAT H (Lanxess)). Further preferred are alkyl ether sulfates (e.g. SULFOROKAnol (PCC Chemax Inc.), ROSULfan OD (PCC Chemax Inc.), EXOsoft MG (PCC Chemax Inc.)), alkyl carboxylates (e.g. Tween 20 (Croda)), benzalkonium chloride (e.g. BTC 1218-50 (ADBAC)), taurides (e.g. Igepon TK (Nantong Tailida Chemical Industry)), or amine oxides (e.g. Tegotens (Evonik)). Organophosphorus compounds such as phosphates, phosphonates, phosphites or phosphoric acid esters (e.g. Servoxyl (KLK Oleo)) can also be used as ionic additives.

The cellulose or starch binder in the metal effect pigment preparation which can be used according to the invention has the function in particular of leading to homogeneous incorporation and adhesion to the powder coating in the bonding process. The metal effect pigments are then attached in a non-agglomerated form to the powder coating binder.

In one preferred embodiment, the metal effect pigment preparation used according to the invention comprises 88-92% by weight, preferably 90% by weight, of an SiO₂-coated aluminium effect pigment, and 5-8% by weight, preferably 6% by weight, of a hydroxypropyl-methylcellulose and 2-4% by weight, preferably 3% by weight, of a nonionic wetting agent based on polyethylene glycol, and 1-2% by weight of residual moisture. This metal effect pigment preparation is present in granule form, preferably as cylindrical granules with a diameter of 1.5 to 2.5 mm and a length of 0.5 to 6 cm, in particular 1 to 5 cm.

In another preferred embodiment, the pigment preparation used according to the invention comprises 78-82% by weight, preferably 80% by weight, of an SiO₂-coated aluminium effect pigment, and 8-12% by weight, preferably 10% by weight, of a hydroxypropyl-methylcellulose and 8-12% by weight, preferably 9% by weight, of a nonionic wetting agent based on polyethylene glycol, and 1-2% by weight of residual moisture.

Another aspect of the invention relates to a process for producing a powder coating, which comprises the following steps:
a) producing a metal effect pigment preparation by mixing a metal effect pigment having a metallic core which optionally contains one or more metal oxide and/or metal hydroxide and/or metal oxide hydrate layers with at least one binder selected from cellulose, cellulose derivative, starch, starch derivative or mixtures thereof, and with a surface-active additive, compacting the resulting mixture in granule form, optionally drying the compacted mixture, wherein the metal effect pigment preparation is in granule form and comprises the following components:
   A) 60-98% by weight, based on the total weight of the metal effect pigment preparation, of at least one metal effect pigment having a metallic core which optionally contains one or more metal oxide and/or metal hydroxide and/or metal oxide hydrate layers,
   B) 1-30% by weight, based on the total weight of the metal effect pigment preparation, of at least one binder selected from cellulose, cellulose derivative, starch, starch derivative or mixtures thereof,
   C) 1-30% by weight, based on the total weight of the metal effect pigment preparation, of a surface-active additive, and
   D) less than 3% by weight, based on the total weight of the metal effect pigment preparation, of residual moisture, the residual moisture comprising water and organic solvents,
b) mixing the metal effect pigment preparation in granule form obtained in step a) together with a powder coating binder and optionally further constituents of a powder coating, and
c) bonding the mixture obtained in step b).

The compaction of the mixture for the production of the metal effect pigment preparation in granule form is preferably carried out by conventional processes such as strand pressing, punch pressing (press with punch and perforated plate) or extrusion, including in particular low-pressure extrusion through a basket extruder, optionally with subsequent drying (at about 20° C. to 150° C., for example above 40° C., preferably between 55 and 65° C.), and comminution with, for example, a rotating knife. Granules in spherical form (with diameters from about 0.05 to about 5 mm, in particular 1 to 3 mm) can be obtained by spray granulation and fluidized bed granulation or with a granulating plate, optionally with subsequent screening.

Bonding can be carried out in commercially available equipment that is currently known in the field of technology (e.g. equipment from Lödige & Pappenmeier, Zeppelin-Henschel, Hosokawa, Plas-Mec or Mixaco), to connect the metal effect pigment preparation with the powder coating. By introduction of energy, e.g. by external heat sources or high shear forces, the powder coating binder is heated up to the glass transition point or higher and admixed with the metal effect pigment preparation. Typical glass transition temperatures are in the range of 50-70° C., in particular between 55 and 65° C. Usually, the amount of metal effect in the powder coating is about 0.5 to 4% by weight, preferably 1 to 3% by weight.

The present invention further relates to a powder coating containing at least one powder coating binder and at least one metal effect pigment preparation as defined in any one of claims 1 to 7 and above, and a substrate coated therewith.

The present invention also relates to the use of the powder coatings according to the invention for coating substrates containing metal, metal foils, plastic, glass, glass fibres, composites, ceramics, wood, concrete, textile material, wood-based materials. Preferred substrates for coating with the powder coatings according to the invention are more particularly pretreated and or cleaned/degreased aluminium alloys or steel and its alloys.

It is understood that the above-stated features and the features to be explained below can be used not only in the specified combinations, but also in other combinations or in isolation, without leaving the scope of the present invention. The stated advantages of features or of combinations of two or more features are merely illustrative and can have an alternative or cumulative effect.

The following examples and comparative examples further elucidate the invention and show advantages of the invention.

### EXAMPLES OF METAL EFFECT PREPARATION USABLE ACCORDING TO THE INVENTION

### Example 1: Granule Production

In 100 mL of cold water, 30 g of Methocel E5 Premium LV binder (hydroxypropyl-methylcellulose (methoxyl content: 28.0-30.0%; hydroxypropoxyl content: 7.0-12.0%; viscosity 2% in water at 20° C.: 4.0-6.0 cP), DuPont) were dissolved. Of this solution, 16.3 g were homogenized together with 2.1 g of PEG 400 (polyethylene glycol, average molar mass: 380-420 g/mol) and 120.68 g of filter cake (Aquamet ST-IL 10600/50 silver dollar coated with SiO₂ in isopropanol (sales product from Schlenk)). The homogenized mixture thus contained 63 g of the SiO₂-coated aluminium pigment. It was pressed via a press with a punch and perforated plate into granules with a diameter of around 2 mm and a length of around 1-5 cm. The granules were then dried in a drying oven at 60° C. for 5 hours. The granules obtained included 89.6% by weight of aluminium pigment, 6.5% by weight of a water-soluble binder, 2.6% by weight of a surface-active additive and 1.3% by weight of residual moisture.

### Example 2: Granule Production

In 100 mL of cold water, 30 g of Methocel E5 Premium LV binder (hydroxypropyl-methylcellulose (methoxyl content: 28.0-30.0%; hydroxypropoxyl content: 7.0-12.0%; viscosity 2% in water at 20° C.: 4.0-6.0 cP), DuPont) were dissolved. Of this solution, 16.3 g were homogenized together with 2.1 g of PEG 400 (polyethylene glycol, average molar mass: 380-420 g/mol) and 90 g of aluminium powder (Powdal 8500 01, silver dollar coated with SiO2 (sales product from Schlenk)). The homogenized mixture thus contained 90 g of the SiO2-coated aluminium pigment. It was pressed via a press with a punch and perforated plate into granules with a diameter of around 2 mm and a length of around 1-5 cm. The granules were then dried in a drying oven at 60° C. for 5 hours. The granules obtained included 89.6% by weight of aluminium pigment, 6.5% by weight of a water-soluble binder, 2.6% by weight of a surface-active additive and 1.3% by weight of residual moisture.

### Comparative Example of Metal Effect Composition

### Comparative Example 3: Metal Effect Powder

Aquamet ST-IL 10600/50 (sales product from Schlenk) is dried at 120° C. in an oven for 5 hours to obtain a powder from the isopropanol paste. The corresponding powder is referred to hereinafter as Comparative Example 3.

### Comparative Example 4: Powdal 8500 01 (Sales Product from Schlenk)

### Characterization of the Metal Effect Pigment Preparations

### Test for Dust-Free Status or Form Retention of the Granules:

To test the dust-free status of the pigment preparation, a defined amount of granules (3 g) is filled into a plastic canister and shaken on a shaker (GFL 3006) for 0.5 h at a shaking frequency of 300 min⁻¹. The granules are then removed from the plastic canister and the abraded material remaining is weighed using an analytical balance. The percentage abrasion is determined in this way.

### Determination of the Residual Solvent Content of the Granules:

In order to determine the residual solvent content of the metal effect pigment preparation, a weighing boat made of thin aluminium foil is placed on the MA35 Ultramat from Sartorius. The weight of the weighing boat is tared and 2 g of the metal effect pigment preparation are placed on it. The cover of the Ultramat is then closed and the metal effect pigment preparation is heated to 120° C. During this time, the weight of the metal effect pigment preparation is continuously determined. When no further weight loss can be registered, the solids content of the metal effect pigment preparation in percent is determined from the initial weight and the remaining weight of the metal effect pigment preparation. The residual moisture of the metal effect pigment preparation corresponds to the value obtained by subtracting the solids from 100%.

### Data of the Metal Effect Pigment Preparations

TABLE 1
Assessment of dust-free status, stability
and environmental impact of the granules.

| | Abrasion | Aluminium pigment |
|---|---|---|
| Examples | in % | content, calculated |
| 1 | 0.01 | 90 |
| 2 | 0.01 | 90 |

The measured values in Table 1 show good form stability of Examples 1 and 2 according to the invention, which show hardly any abrasion after longer-term mechanical stress. A further advantage of Examples 1 and 2 according to the invention is the high metal content, which leads to a low introduction of binder into the coating formulation and to a lower amount of metal effect pigment preparation consumed. In addition, the environmental compatibility of Examples 1 and 2 according to the invention is also very good, and no organic solvents are required for dissolving the binder.

### Application of the Metal Effect Pigment Preparation in Powder Coating

For the application of the metal effect pigment preparation in the powder coating, the preparation must be bonded.

For this purpose, Example 1 according to the invention (metal effect pigment preparation in granule form) is compared with its starting material Aquamet ST-IL 10600/50 (sales product from Schlenk) in powder form (Comparative Example 3). In addition, Example 2 according to the invention (metal effect pigment preparation in granule form) is compared with its starting material Powdal 8500 01 (sales product from Schlenk) (Comparative Example 4).

### Bonding Process:

In the bonding process, the metal effect pigment preparation or the pigment powder is mixed together with the corresponding powder coating (transparent in PES-PRIMID or PES-PRIMID high-gloss black). The material mixture is then brought to the glass transition temperature of the powder coating and heated to 2° C. above the DSC end set point. This is done under a constant mixing motion to ensure complete dispersion of the powder coating/pigment mixture. The pigmentation level of the metal effect pigment preparation in the powder coating is 3% for the transparent PES-PRIMID system and 1% for the high-gloss black PES-PRIMID system. After reaching a specified temperature above the DSC end set point, the mixture is cooled down as quickly as possible to avoid a curing reaction. Before powder application, moreover, a protective screening is also carried out using a sieve with a mesh size of 100 μm to remove possible agglomerates.

### Powder Coating Application:

To apply the bonded powder coating, a powder gun from Gema is used. The bonded transparent PES-PRIMID powder coating is applied to a sheet metal panel with the following gun parameters (20% powder cloud, 2.5 Nm/cm\hat{ }3, 60 mA, 90 kV) and then baked at 180° C. for 20 minutes. The bonded high-gloss black PES-PRIMID powder coating is also applied to a sheet metal panel with the following gun parameters (20% powder cloud, 2.5 Nm/cm\hat{ }3, 60 mA, 90 kV) and then baked at 180° C. for 20 minutes.

### Optical Inspection of the Coating:

The optical properties were measured as follows:

The micro-gloss 60° device from BYK is used to measure the gloss.

### Scanning Electron Microscope Images of the Powder Coatings:

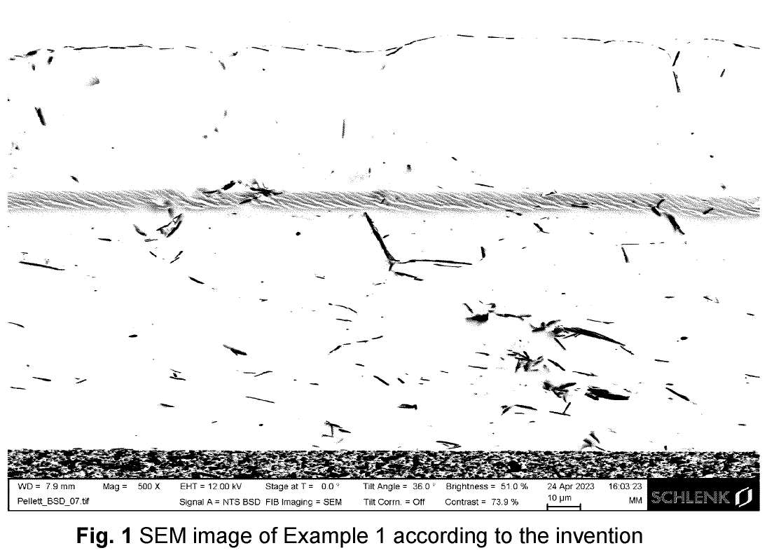

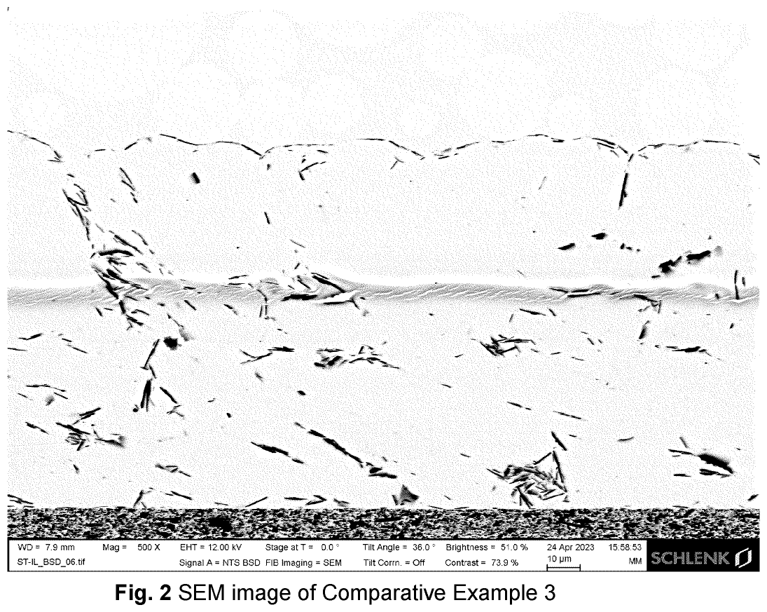

The samples are prepared by cutting the powder-coated sheets into small pieces and embedding them in Technovit 4000 (from Kulzer Technik). The edge of the sheet is then also sanded and polished. The sample is inserted into the scanning electron microscope (Auriga 40 from ZEISS) and the images of Example 1 according to the invention (FIG. 1) and of Comparative Example 3 (FIG. 2) are recorded with the following settings: Working distance=7.9 mm; Magnification=500×; Voltage=12 kV; Stage at T=0.0°; Tilt Angle=36.0°; Brightness=51.0%; Contrast=73.9%; Tilt Corm=Off; FIB Image=SEM; Detector=NTS BSD. The image colours are then inverted for better visibility of the pigments. Hence the pigments are imaged in black and the powder coating matrix in white.

TABLE 2
Measured values of the powder coating application,
bonded in the transparent PES-PRIMID system

| Examples | Gloss 60° |
|---|---|
| Example 1 according to the invention | 151 |
| Comparative Example 3 | 93 |
| Example 2 according to the invention | 89 |
| Comparative Example 4 | 87 |

TABLE 3
Measured values of the powder coating application,
bonded in the high-gloss black PES-PRIMID system

| Examples | Gloss 60° |
|---|---|
| Example 1 according to the invention | 101.0 |
| Comparative Example 3 | 94.9 |

Here it can be seen that Example 1 according to the invention has a significantly higher gloss than Comparative Example 3, both in the black high-gloss PES-PRIMID system and in particular in the transparent PES-PRIMID system. Example 2 according to the invention shows an equivalent gloss in the transparent PES-PRIMID system. This results from the better arrangement of the pigments at the coating surface, which can be seen in the SEM images (FIGS. 1 and 2).

In addition, the dust-free metering of the granule form of Examples 1 and 2 according to the invention significantly reduces the dust load in the bonding process, in contrast to the comparative examples. The handling, storage stability and occupational safety are significantly improved by using the metal effect preparation according to the invention.

1. A metal effect pigment composition in powder coatings, wherein the metal effect pigment composition is in granule form and comprises:
60 to 98% by weight of a metal effect pigment having a metallic core;
1 to 30% by weight of a binder which is at least one selected from the group consisting of cellulose, a cellulose derivative, starch, and a starch derivative;
1 to 30% by weight of a surface-active additive; and
less than 3% by weight of a mixture of water and an organic solvent, each based on a total weight of the metal effect pigment composition.

2. The composition of claim 1, wherein the metal effect pigment is an aluminium effect pigment.

3. The composition of claim 1, wherein the metal effect pigment comprises a layer disposed on the metal core, the layer being at least one selected from the group consisting of a silicon oxide, a vanadium oxide, a molybdenum oxide, a chromium oxide, a titanium oxide, an iron oxide, an aluminum oxide, a tin oxide, a silicon hydroxide, a vanadium hydroxide, a molybdenum hydroxide, a chromium hydroxide, a titanium hydroxide, an iron hydroxide, an aluminum hydroxide, a tin hydroxide, a silicon oxide hydrate, a vanadium oxide hydrate, a molybdenum oxide hydrate, a chromium oxide hydrate, a titanium oxide hydrate, an iron oxide hydrate, an aluminum oxide hydrate, and a tin oxide hydrate.

4. The composition of claim 1, wherein the binder is a water-soluble binder.

5. The composition of claim 1, wherein the surface-active additive is an ionic surface-active additive.

6. The composition of claim 1, wherein the surface-active additive is a nonionic surface-active additive.

7. (canceled)

8. A method of producing powder coatings, the method comprising:
bonding the metal effect pigment composition of claim 1 in granule form with a powder coating binder.

9. A powder coating comprising:
a powder coating binder; and
the metal effect pigment composition of claim 1.

10. A method of producing a powder coating, the method comprising:
mixing a metal effect pigment having a metallic core, a binder, and a surface-active additive to form a first mixture:
compacting the first mixture to form granules of a metal effect pigment composition;
mixing the granules of the metal effect pigment composition with a powder coating binder to form a second mixture; and
bonding the second mixture,
wherein the binder is at least one selected from the group consisting of cellulose, a cellulose derivative, starch, and a starch derivative.

11. The method of claim 10, wherein the bonding comprises heating the second mixture to a temperature of about a glass transition temperature of the powder coating binder.

12. The powder coating of claim 9, wherein the powder coating is disposed on a substrate which is at least one selected from the group consisting of a metal, a metal foil, a plastic, a glass, a glass fiber, a composite, a ceramic, a wood, a concrete, a textile material, and a wood-based material.

13. (canceled)

14. The composition of claim 4, wherein the water-soluble binder is hydroxypropyl-methylcellulose.

15. The composition of claim 6, wherein the nonionic surface-active additive is at least one selected from the group consisting of a polyglycol, polyvinyl butyral (PVB), and polyvinylpyrrolidone (PVP).

16. The composition of claim 15, wherein the polyglycol is at least one selected from the group consisting of polyethylene glycol and polypropylene glycol.

17. The composition of claim 16, wherein the polyethylene glycol has an average molar mass of 200 to 600 g/mol.

18. The method of claim 10, further comprising drying the compacted mixture.

19. The method of claim 10, wherein the metal effect pigment comprises a layer disposed on the metallic core, the layer being at least one selected from the group consisting of a silicon oxide, a vanadium oxide, a molybdenum oxide, a chromium oxide, a titanium oxide, an iron oxide, an aluminum oxide, a tin oxide, a silicon hydroxide, a vanadium hydroxide, a molybdenum hydroxide, a chromium hydroxide, a titanium hydroxide, an iron hydroxide, an aluminum hydroxide, a tin hydroxide, a silicon oxide hydrate, a vanadium oxide hydrate, a molybdenum oxide hydrate, a chromium oxide hydrate, a titanium oxide hydrate, an iron oxide hydrate, an aluminum oxide hydrate, and a tin oxide hydrate.

20. The method of claim 10, wherein the powder coating is disposed on a substrate, wherein the substrate is at least one selected from the group consisting of a metal, a metal foil, a plastic, a glass, a glass fiber, a composite, a ceramic, a wood, a concrete, a textile material, and a wood-based material.
